(19) United States
(12) Patent Application Publication
(10) Pub. No.: US 2006/0176285 A1
(43) Pub. Date: Aug. 10, 2006

(54) Touch sensing display panel

(75) Inventors: Joo-Hyung Lee, Gwacheon-si (KR); Kee-Han Uh, Yongin-si (KR); Sang-Jin Pak, Yongin-si (KR); Myung-Woo Lee, Suwon-si (KR)

Correspondence Address: MacPherson Kwok Chen & Heid LLP, Suite 226, 1762 Technology Drive, San Jose, CA, 95110, US

(73) Assignee: SAMSUNG ELECTRONICS CO., LTD., Suwon-si (KR)

(21) Appl. No.: 11/297,967

(22) Filed: Dec. 9, 2005

(30) Foreign Application Priority Data
Dec. 10, 2004 (KR) 10-2004-0104436

(51) Int. Cl. G09G 5/00

(52) U.S. Cl. 345/173

(57) ABSTRACT

A display panel includes a first pixel occupying a first pixel area and a second pixel occupying a second pixel area that is disposed adjacent to the first pixel area. A sensing element disposed in the first pixel area generates an output signal in response to a touch exerted on the display panel. A switching element is disposed in the second pixel area and is electrically coupled to the sensing element. The switching element selectively outputs a signal received from the sensing element.

### BACKGROUND OF THE INVENTION

(a) Field of the Invention

The present invention relates to a display panel and in particular, a touch sensing display panel.

(b) Description of Related Art

A liquid crystal display (LCD) typically includes a pair of panels provided with pixel electrodes and a common electrode and a liquid crystal layer with dielectric anisotropy interposed between the panels. The pixel electrodes are arranged in a matrix and connected to switching elements such as thin film transistors (TFTs) so that they receive image data voltages on a row-by-row basis. The common electrode covers the entire surface of one of the two panels and it is supplied with a common voltage. A pixel electrode and corresponding portions of the common electrode, and corresponding portions of the liquid crystal layer form a liquid crystal capacitor along with a switching element which is connected thereto defines a basic element of a pixel.

An LCD generates electric fields by applying voltages to pixel electrodes and a common electrode, and varying the strength of the electric fields to adjust the transmittance of light passing through a liquid crystal layer, thereby displaying images.

A touch screen panel is an apparatus on which a finger or a stylus is touched to write characters, to draw pictures, or to instruct a device such as a computer to execute instructions by using icons. The touch screen panel has its own mechanism to determine whether and where a touch exists and it is attached usually on a display device such as an LCD. However, an LCD provided with a touch screen panel has high manufacturing cost due to the cost of the touch screen panel, low productivity due to a step for attaching the touch screen panel to the LCD, reduction of the luminance of the LCD, increase of the thickness of the LCD, etc.

Sensors have been developed for use with thin film transistors incorporated into pixels in an LCD instead of a touch screen panel. A sensor senses the variation of light incident on a panel caused by a touch by user's finger or other instrument. The panel is able to identify that a touch occurred as well as where the touch occurred.

The sensors and signal lines for the sensors can occupy a significant area in the display panel and thus the aperture ratio of the LCD is decreased. In addition, the signal lines for the sensors may be affected by signal lines for the pixels.

### SUMMARY OF THE INVENTION

A display panel according to an embodiment of the present invention includes: a first pixel occupying a first pixel area; a second pixel occupying a second pixel area that is disposed adjacent to the first pixel area; a sensing element disposed in the first pixel area and generating an output signal in response to a touch exerted on the display panel; and a switching element disposed in the second pixel area, electrically coupled to the sensing element, and selectively outputting the output signal from the sensing element.

The sensing element may respond to a light following the touch.

The display panel may further include: an image scanning line connected to the first and the second pixels; a first image data line connected to the first pixel; a second image data line connected to the second pixel; and a sensor data line coupled to the switching element.

The display panel may further include an input voltage line connected to the sensing element.

At least one of the first image data line, the second image data line, the sensor data line, and the input voltage line may be disposed between the first pixel area and the second pixel area. The display panel may further include a connecting member connecting the sensing element and the switching element and intersecting the at least one of the first image data line, the second image data line, and a sensor data line. A first one of the first image data line, the second image data line, the sensor data line, and the input voltage line may be disposed on a second one of the first image data line, the second image data line, the sensor data line, and the input voltage line. In particular, the input voltage line may be disposed on one of the first image data line, the second image data line, and a sensor data line.

At least one of the first image data line, the second image data line, the sensor data line, and the input voltage line may be disposed in the first pixel area or the second pixel area.

None of the first image data line, the second image data line, the sensor data line, and the input voltage line may be disposed between the first pixel area and the second pixel area. In particular, none of the first image data line and the second image data line may be disposed between the first pixel area and the second pixel area.

The image scanning line may include a first layer and the first image data line and the second image data line may include a second layer different from the first layer. Each of the first pixel and the second pixel may include a pixel electrode including a third layer different from the first and the second layers.

The sensor data line and the input voltage line may include the second layer or the third layer.

The display panel may further include: a sensor scanning line connected to the switching electrode and including the first layer; and a control voltage line connected to the sensing element and including the first layer.

The sensing element and the switching element may include amorphous silicon or polysilicon.

### BRIEF DESCRIPTION OF THE DRAWINGS

The above and other aspects of the present invention will become more apparent in light of the description of the following embodiments with reference to the accompanying drawing figures in which:

FIG. 1 is a block diagram of an LCD according to an embodiment of the present invention;

FIG. 2 is an equivalent circuit diagram of a pixel of an LCD according to an embodiment of the present invention;

FIG. 3 is an equivalent circuit diagram of a pixel which includes a sensing element of an LCD according to an embodiment of the present invention;

FIGS. 4A and 4B illustrate an arrangement of pixels and sensing units of an LCD according to an embodiment of the present invention; and

FIGS. 5, 6, 7, 8, 9 and 10 are schematic equivalent circuit diagrams of pixels and sensing units according to embodiments of the present invention.

### DETAILED DESCRIPTION OF EMBODIMENTS

The present invention is described fully below with reference to the accompanying drawings, in which preferred embodiments of the invention are shown.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

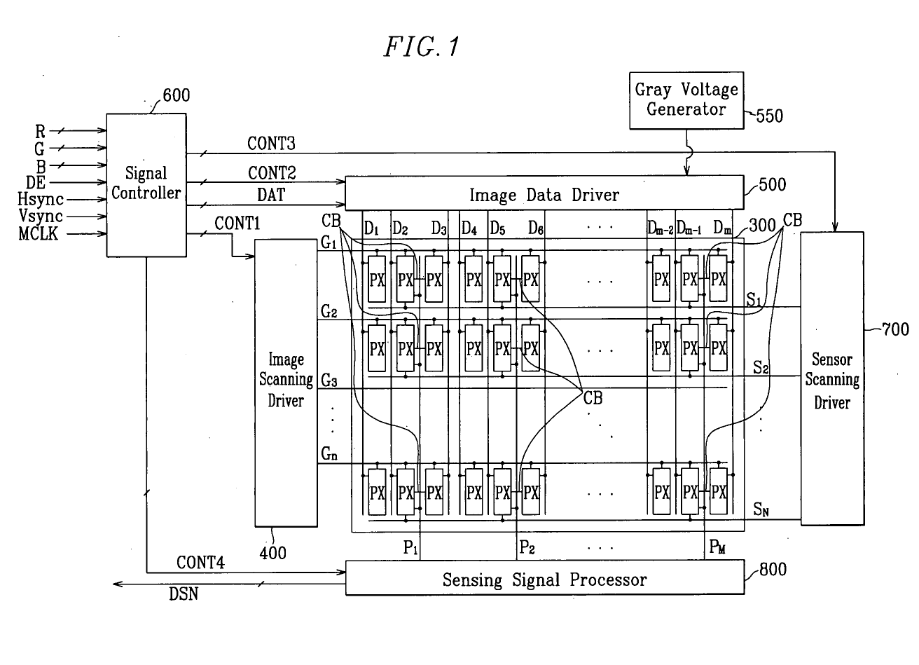

A liquid crystal display according to an embodiment of the present invention now is described in detail with reference to FIGS. 1, 2, 3 and 4.

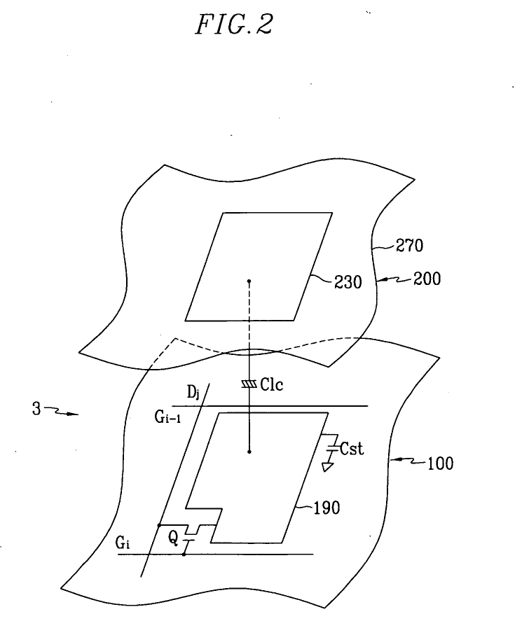

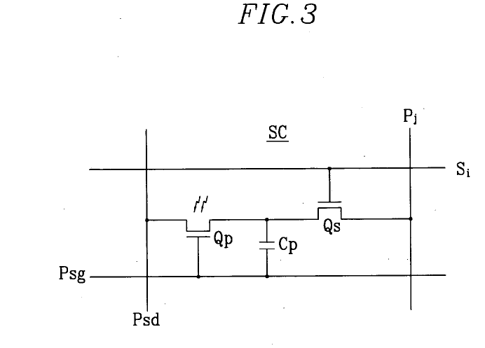

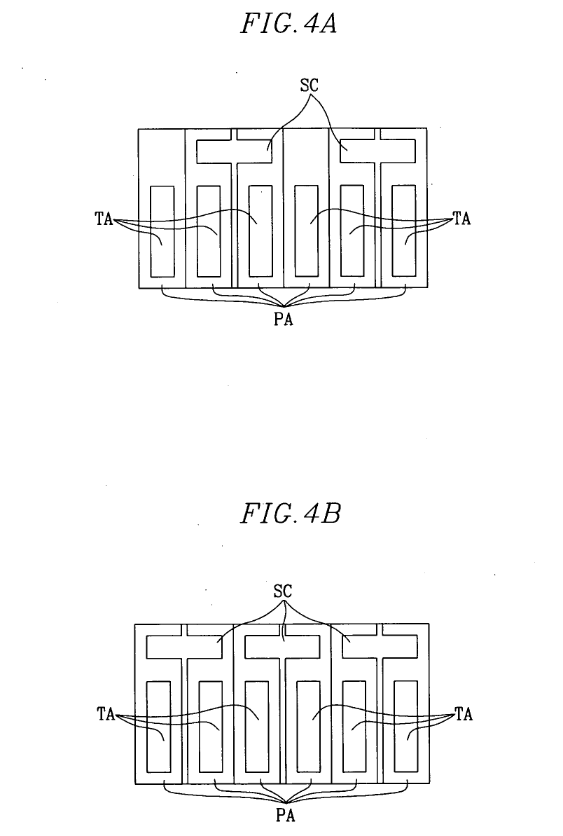

FIG. 1 is a block diagram of an LCD according to an embodiment of the present invention. FIG. 2 is an equivalent circuit diagram of a pixel of an LCD according to an embodiment of the present invention. FIG. 3 is an equivalent circuit diagram of a pixel including a sensing unit for an LCD according to an embodiment of the present invention, and FIGS. 4A and 4B illustrate an arrangement of pixels and sensing units of an LCD according to an embodiment of the present invention.

Referring to FIG. 1, an LCD according to an embodiment includes a liquid crystal (LC) panel assembly 300, an image scanning driver 400, an image data driver 500, a sensor scanning driver 700, and a sensing signal processor 800 which are coupled to the panel assembly 300. A gray voltage generator 550 is coupled to the image data driver 500, and a signal controller 600 is coupled to the above elements.

Referring to FIGS. 1-4, the panel assembly 300 includes a plurality of display signal lines G₁-Gₙ and D₁-Dₘ, a plurality of sensor signal lines S₁-S_{N}, P₁-P_{M}, Psg and Psd, a plurality of pixels PX connected to the display signal lines G₁-Gₙ and D₁-Dₘ and which are arranged substantially in a matrix, and a plurality of sensing units SC (FIG. 3) connected to the sensor signal lines S₁-S_{N}, P₁-P_{M}, Psg and Psd and arranged substantially in a matrix. In the structural view shown in FIG. 2, the panel assembly 300 includes a lower panel 100 and an upper panel 200 facing each other and a liquid crystal (LC) layer 3 interposed between the lower panel 100 and the upper panel 200.

The display signal lines include a plurality of image scanning lines G₁-Gₙ transmitting image scanning signals and a plurality of image data lines D₁-Dₘ transmitting image data signals.

The sensor signal lines include a plurality of a plurality of sensor scanning lines S₁-S_{N} which transmit sensor scanning signals, a plurality of sensor data lines P₁-P_{M} which transmit sensor data signals, a plurality of control voltage lines Psg (FIG. 3) transmitting a sensor control voltage, and a plurality of input voltage lines Psd (FIG. 3) which transmit a sensor input voltage.

The image scanning lines G₁-Gₙ and the sensor scanning lines S₁-S_{N} extend substantially in a row direction and are substantially parallel to each other, while the image data lines D₁-Dₘ and the sensor data lines P₁-P_{M} extend substantially in a column direction and are substantially parallel to each other.

Referring to FIG. 2, each pixel PX, for example, a pixel in the i-th row (i=1, 2, . . . , n) and the j-th column (j=1, 2, . . . , m) includes a switching element Q connected to an image scanning line Gᵢ and an image data line Dⱼ, and a LC capacitor Clc and a storage capacitor Cst that are connected to the switching element Q. Use of the storage capacitor Cst is optional.

The switching element Q is disposed on the lower panel 100 and it has three terminals, i.e., a control terminal connected to the image scanning line Gᵢ, an input terminal connected to the image data line Dⱼ, and an output terminal connected to the LC capacitor Clc and the storage capacitor Cst.

The LC capacitor Clc includes a pixel electrode 190 disposed on the lower panel 100 and a common electrode 270 disposed on the upper panel 200 as two terminals. The LC layer 3 disposed between the two electrodes 190 and 270 functions as dielectric of the LC capacitor Clc. The pixel electrode 190 is connected to the switching element Q, and the common electrode 270 is supplied with a common voltage Vcom and covers an entire surface of the upper panel 200. Alternatively, the common electrode 270 may be provided on the lower panel 100, and at least one of the electrodes 190 and 270 may have a shape of bar or stripe.

The storage capacitor Cst is an auxiliary capacitor for the LC capacitor Clc. The storage capacitor Cst includes the pixel electrode 190 and a separate signal line, which is provided on the lower panel 100, overlaps the pixel electrode 190 via an insulator, and is supplied with a predetermined voltage such as the common voltage Vcom. Alternatively, the storage capacitor may include the pixel electrode 190 and an adjacent gate line called a previous gate line, which overlaps the pixel electrode 190 via an insulator.

For a color display, each pixel uniquely represents one of primary colors (i.e., spatial division) or each pixel sequentially represents the primary colors in turn (i.e., temporal division) such that the spatial or temporal sum of the primary colors are recognized as a desired color. An example of a set of the primary colors includes red, green, and blue colors. FIG. 2 shows an example of the spatial division in which each pixel includes a color filter 230 representing one of the primary colors in an area of the upper panel 200 facing the pixel electrode 190. Alternatively, the color filter 230 can be provided on or under the pixel electrode 190 on the lower panel 100.

One or more polarizers (not shown) are attached to at least one of the panels 100 and 200. In addition, one or more retardation films (not shown) for compensating refractive anisotropy may be disposed between the polarizer(s) and the panel(s).

Referring to FIG. 3, each of the sensing units SC includes a sensing element Qp connected to a control voltage line Psg and an input voltage line Psd. A sensor capacitor Cp is connected to the sensing element Qp, and a switching element Qs, the control terminal of which is connected to a sensor scanning line Sᵢ. The primary current flow terminals of Qs are connected to sensing element Qp, and a sensor data line Pⱼ.

The sensing element Qp has three terminals, i.e., a control terminal connected to the control voltage line Psg to be biased by the sensor control voltage, an input terminal connected to the input voltage line Psd to be biased by the sensor input voltage, and an output terminal connected to the switching element Qs. The sensing element Qp includes a photoelectric material that generates a photocurrent in response to receipt of light. Sensing element Qp may be implemented by a thin film transistor having an amorphous silicon or polysilicon channel that can generate a photocurrent. The sensor control voltage applied to the control terminal of the sensing element Qp is sufficiently low or sufficiently high to keep the sensing element Qp in an off state without incident light. The sensor input voltage applied to the input terminal of the sensing element Qp is sufficiently high or sufficiently low to keep the photocurrent flowing in a direction. The photocurrent flows toward the switching element Qs as a result of the application of the sensor input voltage, and it also flows into the sensor capacitor Cp to charge the sensor capacitor Cp.

The sensor capacitor Cp is connected between the control terminal and the output terminal of the sensing element Qp. The sensor capacitor Cp stores electrical charge output from the sensing element Qp to maintain a predetermine voltage. Use of the sensor capacitor Cp is optional.

The switching element Qs also has three terminals, i.e., a control terminal connected to the sensor scanning line Sᵢ, an input terminal connected to the output terminal of the sensing element Qp, and an output terminal connected to the sensor data line Pⱼ. The switching element Qs outputs a sensor output signal to the sensor data line Pⱼ in response to the sensor scanning signal from the sensor scanning line Sᵢ. The sensor output signal is the sensing current from the sensing element Qp. However, the sensor output signal may be a voltage stored in the sensor capacitor Cp.

The switching elements Q and Qs and the sensing element Qp may include amorphous silicon or polysilicon thin film transistors (TFTs).

In FIGS. 4A and 4B, an area occupied by a pixel PX is denoted as PA.

One sensing unit SC is disposed in two adjacent pixel areas PA. The sensing element Qp is disposed in one of the two pixel areas PA, and the switching element Qs is disposed in the other of the pixel areas PA. The sensing element Qp and the switching element Qs are connected to each other through a connecting member CB as shown in FIG. 1.

The control voltage line Psg and the sensor scanning lines S₁-S_{N} run across the pixel areas PA. The sensor data lines P₁-P_{M} and the input voltage line Psd are disposed between the pixel areas PA with being disposed out of the pixel areas PA or may be disposed in different pixel areas PA.

A concentration of the sensing units SC may be equal to a concentration of dots as shown in FIG. 4A, where a dot is the basic unit for representing a color and includes a set of different-colored pixels. The set of pixels which define a dot may include, for example, a red pixel, a green pixel, and a blue pixel sequentially arranged in a row as shown in FIG. 4A.

Alternatively, the concentration of the sensing units SC may be one half of the concentration of the pixels as shown in FIG. 4B.

Two or more adjacent sensor scanning lines S₁-S_{N} may be connected to each other such that the sensor output signals of the sensing units SC connected to the sensor scanning lines are superposed to form a sensor data signal. This configuration may reduce the variation of the characteristics of the sensing units SC, and the generated sensor data signal may have a doubled signal-to-noise ratio to contain more precise touch information.

The sensing unit SC may be alternatively be implemented with a sensing unit that senses another physical quantity such as pressure rather than light.

Referring to FIG. 1 again, the gray voltage generator 800 generates two sets of a plurality of gray voltages related to the transmittance of the pixels. The gray voltages in one set have a positive polarity with respect to the common voltage Vcom, while those in the other set have a negative polarity with respect to the common voltage Vcom.

The image scanning driver 400 is connected to the image scanning lines G₁-Gₙ of the panel assembly 300 and synthesizes a gate-on voltage and a gate-off voltage to generate the image scanning signals for application to the image scanning lines G₁-Gₙ.

The image data driver 500 is connected to the image data lines D₁-Dₘ of the panel assembly 300 and applies image data signals, which are selected from the gray voltages supplied from the gray voltage generator 800, to the image data lines D₁-Dₘ.

The sensor scanning driver 700 is connected to the sensor scanning lines S₁-S_{N} of the panel assembly 300 and synthesizes a gate-on voltage and a gate-off voltage to generate the sensor scanning signals for application to the sensor scanning lines S₁-S_{N}.

The sensing signal processor 800 is connected to the sensor data lines P₁-P_{M} of the display panel 300 and receives and analog-to-digital converts the sensor data signals from the sensor data lines P₁-P_{M} to generate digital sensor data signals DSN. The sensor data signals carried by the sensor data lines P₁-P_{M} may be current signals and in this case, the sensing signal processor 800 converts the current signals into voltage signals before the analog-to-digital conversion. One sensor data signal carried by one sensor data line P₁-P_{M} at a time may include one sensor output signal from one switching elements Qs or may include at least two sensor output signals outputted from at least two switching elements Qs.

The signal controller 600 controls the image scanning driver 400, the image data driver 500, the sensor scanning driver 700, and the sensing signal processor 800, etc.

Each of the processing units 400, 500, 550, 600, 700 and 800 may include at least one integrated circuit (IC) chip mounted on the LC panel assembly 300 or on a flexible printed circuit (FPC) film in a tape carrier package (TCP) type, which are attached to the panel assembly 300. Alternately, at least one of the processing units 400, 500, 550, 600, 700 and 800 may be integrated into the panel assembly 300 along with the signal lines G₁-Gₙ, D₁-Dₘ, S₁-S_{N}, P₁-P_{M}, Psg and Psd, the switching elements Q and Qs, and the sensing elements Qp. Alternatively, all the processing units 400, 500, 550, 600, 700 and 800 may be integrated into a single IC chip, but at least one of the processing units 400, 500, 550, 600, 700 and 800 or at least one circuit element in at least one of the processing units 400, 500, 550, 600, 700 and 800 may be disposed out of the single IC chip.

The operation of the above-described LCD is described below in detail.

The signal controller 600 is supplied with input image signals R, G and B and input control signals for controlling the display thereof from an external graphics controller (not shown). The input control signals include a vertical synchronization signal Vsync, a horizontal synchronization signal Hsync, a main clock MCLK, and a data enable signal DE.

On the basis of the input control signals and the input image signals R, G and B, the signal controller 600 generates image scanning control signals CONT1, image data control signals CONT2, sensor scanning control signals CONT3, and sensor data control signals CONT4 and it processes the image signals R, G and B suitable for the operation of the display panel 300. The signal controller 600 sends the scanning control signals CONT1 to the image scanning driver 400, the processed image signals DAT and the data control signals CONT2 to the data driver 500, the sensor scanning control signals CONT3 to the sensor scanning driver 700, and the sensor data control signals CONT4 to the sensing signal processor 800.

The image scanning control signals CONT1 include an image scanning start signal STV for instructing to start image scanning and at least one clock signal for controlling the output time of the gate-on voltage. The image scanning control signals CONT1 may include an output enable signal OE for defining the duration of the gate-on voltage.

The image data control signals CONT2 include a horizontal synchronization start signal STH for informing of start of image data transmission for a group of pixels PX, a load signal LOAD for instructing to apply the image data signals to the image data lines D₁-Dₘ, and a data clock signal HCLK. The image data control signal CONT2 may further include an inversion signal RVS for reversing the polarity of the image data signals (with respect to the common voltage Vcom.

Responsive to the image data control signals CONT2 from the signal controller 600, the data driver 500 receives a packet of the digital image signals DAT for the group of pixels PX from the signal controller 600, converts the digital image signals DAT into analog image data signals selected from the gray voltages supplied from the gray voltage generator 800, and applies the analog image data signals to the image data lines D₁-Dₘ.

The image scanning driver 400 applies the gate-on voltage to an image scanning line G₁-Gₙ in response to the image scanning control signals CONT1 from the signal controller 600, thereby turning on the switching transistors Q connected thereto. The image data signals applied to the image data lines D₁-Dₘ are then supplied to the pixels PX through the activated switching transistors Q.

The difference between the voltage of an image data signal and the common voltage Vcom is represented as a voltage across the LC capacitor Clc, which is referred to as a pixel voltage. The LC molecules in the LC capacitor Clc have orientations depending on the magnitude of the pixel voltage, and the molecular orientations determine the polarization of light passing through the LC layer 3. The polarizer(s) converts the light polarization into the light transmittance to display images.

By repeating this procedure by a unit of a horizontal period (also referred to as “1H” and equal to one period of the horizontal synchronization signal Hsync and the data enable signal DE), all image scanning lines G₁-Gₙ are sequentially supplied with the gate-on voltage, thereby applying the image data signals to all pixels PX to display an image for a frame.

When the next frame starts after the preceding frame finishes, the inversion control signal RVS applied to the data driver 500 is controlled such that the polarity of the image data signals is reversed (which is referred to as “frame inversion”). The inversion control signal RVS may be also controlled such that the polarity of the image data signals flowing in a data line are periodically reversed during one frame (for example, row inversion and dot inversion), or the polarity of the image data signals in one packet are reversed (for example, column inversion and dot inversion).

Concurrently, the sensor scanning driver 700 applies the gate-off voltage to the sensor scanning lines S₁-S_{M} to turn on the switching elements Qs connected thereto in response to the sensing control signals CONT3. Then, the switching elements Qs output sensor output signals to the sensor data lines P₁-P_{M} to form sensor data signals, and the sensor data signals are inputted into the sensing signal processor 800.

The sensing signal processor 800 processes, for example, amplifies and filters the read sensor data signals and converts the analog sensor data signals into digital sensor data signals DSN to be sent to an external device (not shown) in response to the sensor data control signals CONT4. The external device appropriately processes signals form the sensing signal processor 800 to determine whether and where a touch exists. The external device 600 sends image signals generated based on the touch information to the LCD.

The sensing operation may be performed independently of the display operation. The sensing operation repeats in one or several horizontal periods depending on the concentration of the sensing units SC. The sensing operation will not necessarily be performed every frame, rather it may be performed every two or more frames.

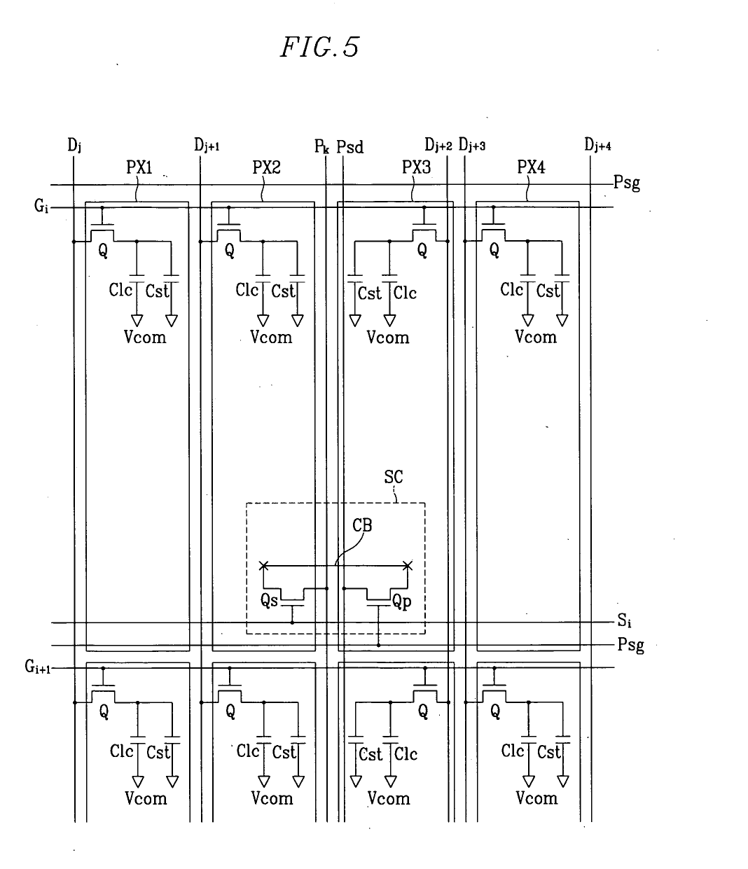

LC panel assemblies according to embodiments of the present invention are described below in detail with reference to FIGS. 5, 6, 7, 8, 9 and 10.

FIGS. 5, 6, 7, 8, 9 and 10 are schematic equivalent circuit diagrams of pixels and sensing units according to embodiments of the present invention.

Each of panel assemblies shown in FIGS. 5-10 includes a plurality of signal lines Gᵢ, Gᵢ₊₁, Dⱼ, Dⱼ₊₁, Dⱼ₊₂, Dⱼ₊₃, Dⱼ₊₄, Sᵢ, Pₖ, Psg and Psd, first, second, third, and fourth pixels PX1, PX2, PX3 and PX4 arranged in a matrix, and a sensing unit SC.

The signal lines include display signal lines Gᵢ, Gᵢ₊₁ and Dⱼ-Dⱼ₊₄ and sensing signal lines Sᵢ, Pₖ, Psg and Psd. The display signal lines include image scanning lines Gᵢ and Gᵢ₊₁ extending in a row direction and image data lines Dⱼ-Dⱼ₊₄ extending in a column direction. The sensing signal lines include a sensor scanning line Sᵢ and a control voltage line Psg, which extend in the row direction, and an image data line Pₖ and an input voltage line Psd, which extend in the column direction.

Each of the first to fourth pixels PX1-PX4 is connected to the image scanning line Gᵢ and the image data lines Dⱼ, Dⱼ₊₁, Dⱼ₊₂ and Dⱼ₊₃, respectively, and each pixel includes a switching element Q, and a LC capacitor Clc and a storage capacitor Cst which are coupled to the switching element Q. Each of the pixels PX1-PX4 occupies a “pixel area,” (where the terms pixel and the pixel area are used hereinafter interchangeably). A pixel electrode (270 shown in FIG. 2) is provided for each of the pixels PX1-PX4 and covers almost all the pixel area. In FIG. 5 a set of three successive pixels define a unit of repetition and thus the fourth pixel PX4 is a replica of the first pixel PX1.

The sensing unit SC is connected to the sensor scanning line Sᵢ and the sensor data line Pₖ and includes a switching element Qs and a sensing element Qp.

The switching element Qs is disposed in the second pixel PX2 and the sensing element Qp is disposed in the third pixel PX3. The switching element Qs has a control electrode connected to the sensor scanning line Sᵢ, an output electrode connected to the sensor data line Pₖ, and an input electrode. The sensing element Qp has a control electrode connected to the control voltage line Psg, an input electrode connected to the input voltage line Psd, and an output electrode. The output electrode of the sensing element Qp and the input electrode of the switching element Qs are electrically connected to each other.

The image scanning lines Gᵢ and Gᵢ₊₁, the image data lines Dⱼ-Dⱼ₊₄, and the pixel electrodes are formed using different layers of material. The image scanning lines Gᵢ and Gᵢ₊₁, are formed of a gate layer, the image data lines Dⱼ-Dⱼ₊₄ are formed of a data layer, and the pixel electrodes are formed of a pixel layer. The gate layer and the data layer may include metal, and the pixel electrodes may include a transparent conductor such as indium tin oxide (ITO) or indium zinc oxide (IZO). The gate layer and the data layer may be disposed under the pixel layer, and the gate layer may be disposed under or on the data layer. The gate layer, the data layer, and the pixel layer may be insulated from one another with interposing insulators.

The sensor scanning line Sᵢ and the control voltage line Psg extend across the pixels PX1-PX4 and are formed using the same layer of material from which the gates are defined.

The sensor data line Pₖ and the input voltage line Psd may be disposed between two adjacent pixels PX2 and PX3 or disposed in one of the pixels PX2 and PX3 to be covered with a pixel electrode. The sensor data line Pₖ and the input voltage line Psd may be formed of the data layer or the pixel layer.

The control electrodes of the sensing element Qp and the switching element Qs are formed of the gate layer, and the input and output electrodes of the sensing element Qp and the switching element Qs are formed of the data layer.

When the sensor data line Pₖ and the input voltage line Psd are formed of the pixel layer, contact holes, which may be provided in insulators disposed between the data layer and the pixel layer, are required for connecting the output electrode of the switching element Qs to the sensor data line Pₖ and for connecting the input electrode of the sensing element Qp to the input voltage line Psd.

The electrical connection between the output electrode of the sensing element Qp and the input electrode of the switching element Qs are implemented with or without a connecting member CB depending on whether an obstruction is disposed in the way from one to the other. The obstruction may be at least one of the image data lines Dⱼ-Dⱼ₊₄, the sensor data line Pₖ, or the input voltage line Psd, which are made of the data layer. The connecting member CB is formed of the gate layer such that the connecting member CB passes over or under the obstruction. The connecting member CB are connected to the output electrode of the sensing element Qp and the input electrode of the switching element Qs through contact holes denoted by X, which may be provided in insulators disposed between the gate layer and the data layer.

The position of the sensing element Qp and the switching element Qs may be interchanged.

### EXAMPLE 1

FIG. 5

Referring to FIG. 5, the sensor data line Pₖ is disposed between the second pixel PX2 and the third pixel PX3 and formed of the data layer.

The input voltage line Psd is disposed adjacent to the sensor data line Pₖ. The input voltage line Psd is formed of the data layer, and the input voltage line Psd is disposed in the third pixel PX3 to be covered with the pixel electrode of the third pixel PX3. Otherwise, the input voltage line Psd may be disposed on the sensor data line Pₖ and the input voltage line Psd may be formed of the pixel layer.

The image data line Dⱼ₊₂ coupled to the third pixel PX3 is disposed near the right side of the third pixel PX3 unlike other image data lines Dⱼ, Dⱼ₊₁, Dⱼ₊₃ and Dⱼ₊₄,. The data line Dⱼ₊₂ is disposed in the third pixel PX3 to be covered with the pixel electrode of the third pixel PX3. However, the data line Dⱼ₊₂ maybe disposed out of the third pixel PX3.

The output electrode of the sensing element Qp and the input electrode of the switching element Qs are disposed far from the sensor data line Pₖ and the input voltage line Psd. The output electrode of the sensing element Qp and the input electrode of the switching element Qs are connected to each other thorough the connecting member CB across the sensor data line Pₖ and the input voltage line Psd.

As described above, the sensing unit SC is disposed in two pixels PX2 and PX3 and the sensing signal lines Pₖ and Psd are disposed between the two pixels PX2 and PX3 such that the transmissive area of the pixels is increased to increase the transmittance.

In addition, the sensor data line Pₖ is spaced apart from the image data line Dⱼ₊₂ with interposing the pixel PX2 such that the sensor data signals are less affected by voltages of the image data signals and thus the distortion of the sensor data signals can be reduced. Furthermore, when the input voltage line Psd supplied with a constant voltage is disposed on the sensor data line Pₖ, the electrical coupling between the sensor data line Pₖ and the pixel electrode and the common electrode (270 shown in FIG. 2) is reduced to decrease the distortion of the sensor data signals.

### EXAMPLE 2

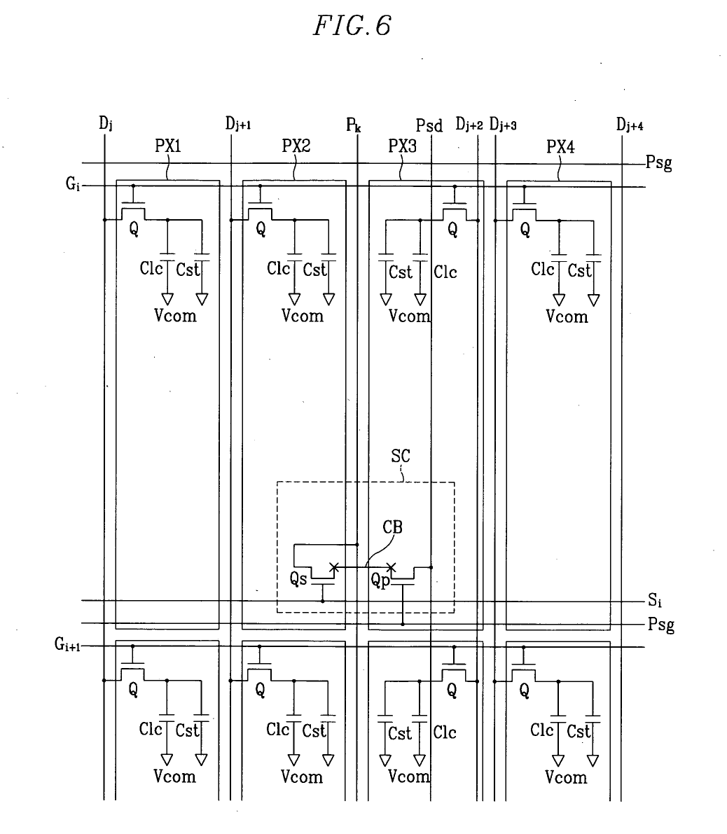

FIG. 6

Referring to FIG. 6, the sensor data line Pₖ is disposed between the second pixel PX2 and the third pixel PX3 and formed of the data layer. However, the sensor data line Pₖ may be formed of the pixel layer.

The input voltage line Psd is disposed in the third pixel PX3 and formed of the data layer.

The image data line Dⱼ₊₂ coupled to the third pixel PX3 is disposed near the right side of the third pixel PX3 unlike other image data lines Dⱼ, Dⱼ₊₁, Dⱼ₊₃ and Dⱼ₊₄,. The data line Dⱼ₊₂ is disposed in the third pixel PX3 to be covered with the pixel electrode of the third pixel PX3. However, the data line Dⱼ₊₂ maybe disposed out of the third pixel PX3.

The output electrode of the sensing element Qp and the input electrode of the switching element Qs are disposed close to the sensor data line Pₖ and the input voltage line Psd. The output electrode of the sensing element Qp and the input electrode of the switching element Qs are connected to each other thorough the connecting member CB across the sensor data line Pₖ.

However, when the sensor data line Pₖ is formed of the pixel layer, the connecting member CB may be omitted and the output electrode of the sensing element Qp and the input electrode of the switching element Qs may extend to each other to be connected.

### EXAMPLE 3

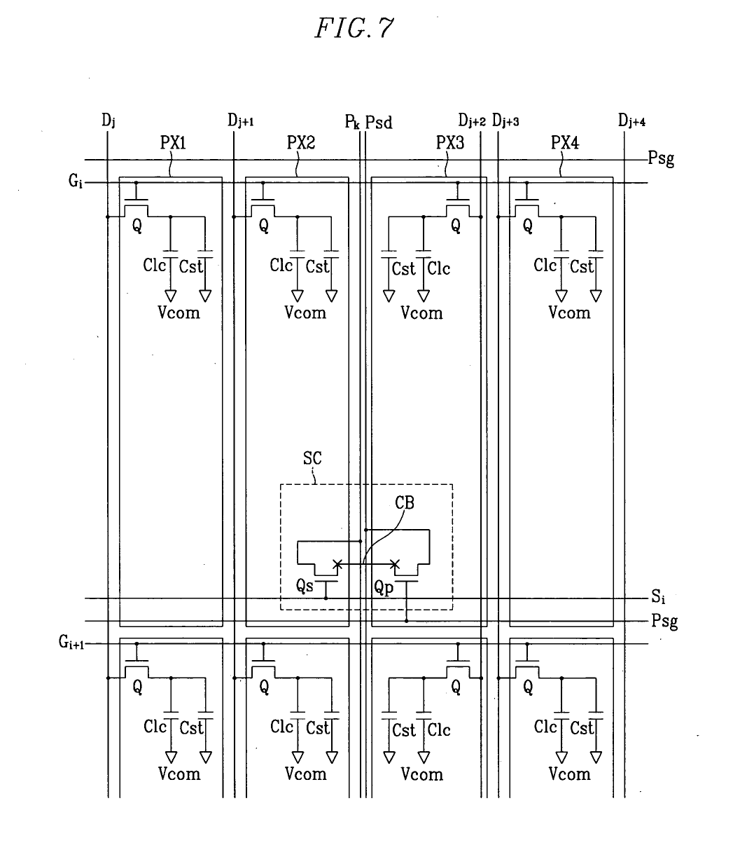

FIG. 7

Referring to FIG. 7, the sensor data line Pₖ is disposed between the second pixel PX2 and the third pixel PX3 and formed of the data layer.

The input voltage line Psd is disposed between the second pixel PX2 and the third pixel PX3 and formed of the data layer or the pixel layer. When the input voltage line Psd is formed of the pixel layer, the input voltage line Psd may be disposed on the sensor data line Pₖ.

The image data line Dⱼ₊₂ coupled to the third pixel PX3 is disposed near the right side of the third pixel PX3 unlike other image data lines Dⱼ, Dⱼ₊₁, Dⱼ₊₃ and D_{j+4′}. The data line Dⱼ₊₂ is disposed in the third pixel PX3 to be covered with the pixel electrode of the third pixel PX3. However, the data line Dⱼ₊₂ may be disposed out of the third pixel PX3.

The output electrode of the sensing element Qp and the input electrode of the switching element Qs are disposed close to the sensor data line Pₖ and the input voltage line Psd. The output electrode of the sensing element Qp and the input electrode of the switching element Qs are connected to each other thorough the connecting member CB across the sensor data line Pₖ and the input voltage line Psd.

### EXAMPLE 4

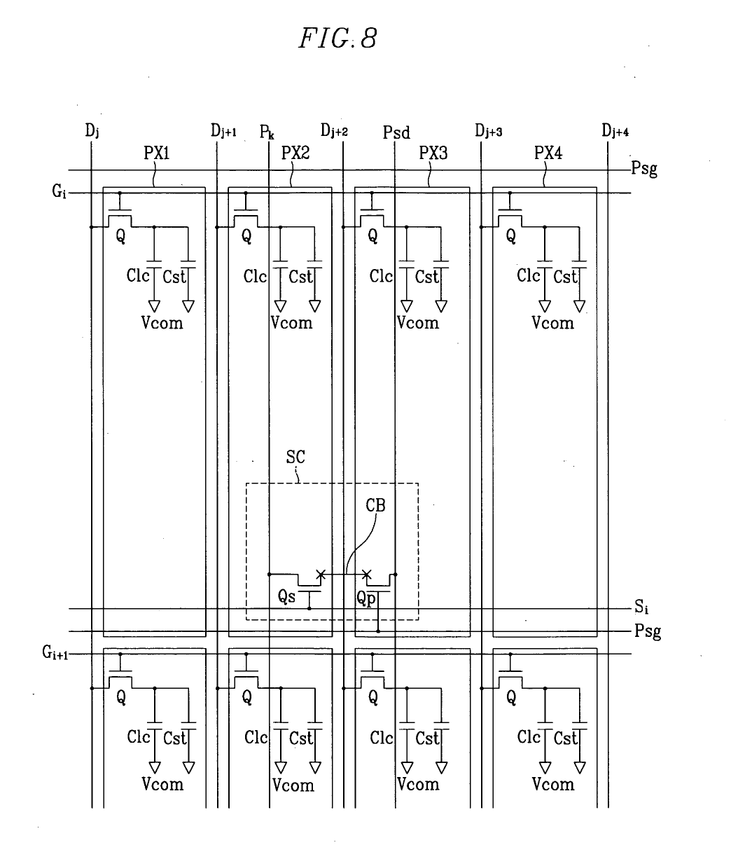

FIG. 8

Referring to FIG. 8, the sensor data line Pₖ is disposed in the second pixel PX2 and formed of the data layer.

The input voltage line Psd is disposed in the third pixel PX3 and formed of the data layer.

The image data line Dⱼ₊₂ coupled to the third pixel PX3 is disposed left to the third pixel PX3 like other image data lines Dⱼ, D_{j+1, D}ⱼ₊₃ and D_{j+4′}. The data line Dⱼ₊₂ may be disposed in the third pixel PX3 to be covered with the pixel electrode of the third pixel PX3.

The output electrode of the sensing element Qp and the input electrode of the switching element Qs are disposed close to the sensor data line Pₖ and the input voltage line Psd. The output electrode of the sensing element Qp and the input electrode of the switching element Qs are connected to each other thorough the connecting member CB across the image data line Dⱼ₊₂.

### EXAMPLE 5

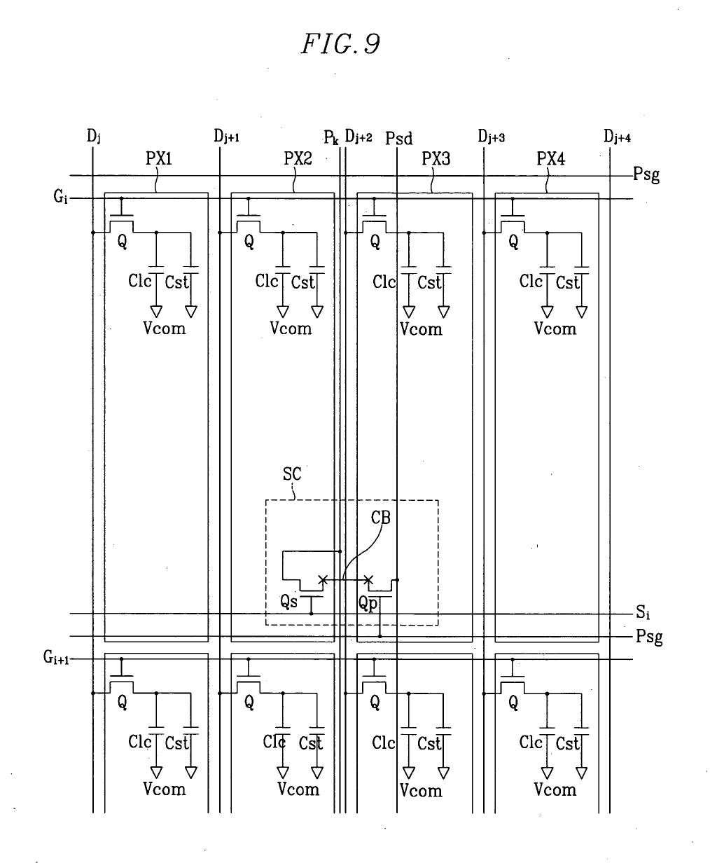

FIG. 9

Referring to FIG. 9, the sensor data line Pₖ is disposed between the second pixel PX2 and the third pixel PX3 and formed of the data layer. However, the sensor data line Pₖ may be formed of the pixel layer.

The input voltage line Psd is disposed in the third pixel PX3 and formed of the data layer. However, the input voltage line Psd may be disposed between the second pixel PX2 and the third pixel PX3.

The image data line Dⱼ₊₂ coupled to the third pixel PX3 is disposed left to the third pixel PX3 like other image data lines Dⱼ, Dⱼ₊₁, Dⱼ₊₃ and D_{j+4′}. The data line Dⱼ₊₂ may be disposed in the third pixel PX3 to be covered with the pixel electrode of the third pixel PX3. When the sensor data line Pₖ is formed of the pixel layer, the sensor data line Pₖ may be disposed on the image data line Dⱼ₊₂.

The output electrode of the sensing element Qp and the input electrode of the switching element Qs are disposed close to the sensor data line Pₖ and the input voltage line Psd. The output electrode of the sensing element Qp and the input electrode of the switching element Qs are connected to each other thorough the connecting member CB across the image data line Dⱼ₊₂ and the sensor data line Pₖ.

### EXAMPLE 6

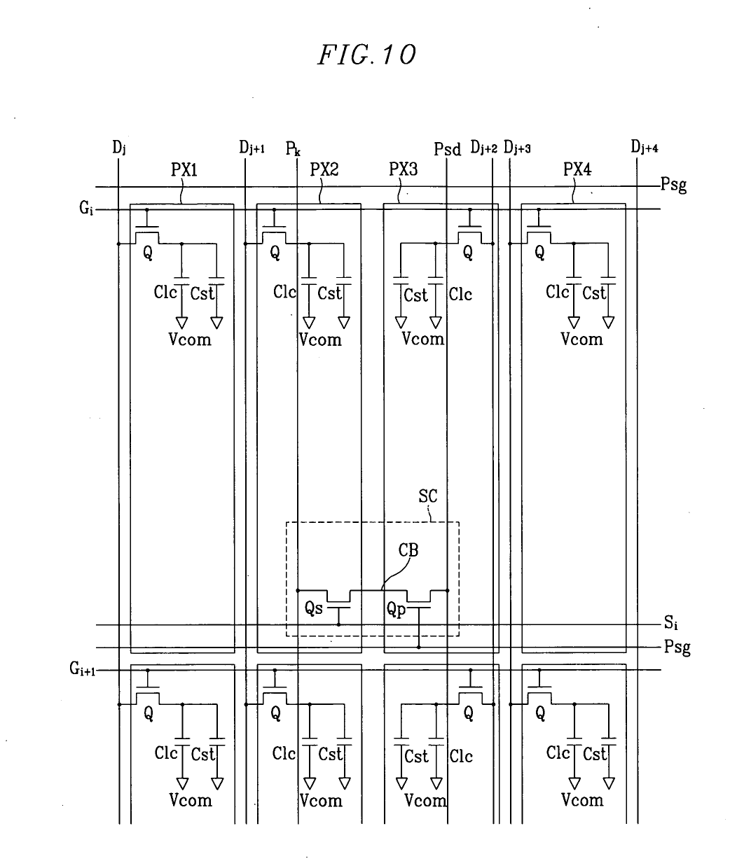

FIG. 10

Referring to FIG. 10, the sensor data line Pₖ is disposed in the second pixel PX2 and formed of the data layer.

The input voltage line Psd is disposed in the third pixel PX3 and formed of the data layer.

The image data line Dⱼ₊₂ coupled to the third pixel PX3 is disposed near the right side of the third pixel PX3 unlike other image data lines Dⱼ, Dⱼ₊₁, Dⱼ₊₃ and Dⱼ₊₄, The data line Dⱼ₊₂ is disposed in the third pixel PX3 to be covered with the pixel electrode of the third pixel PX3. However, the data line Dⱼ₊₂ may be disposed out of the third pixel PX3.

The output electrode of the sensing element Qp and the input electrode of the switching element Qs are disposed close to the sensor data line Pₖ and the input voltage line Psd.

Since there is no signal line between the second pixel PX2 and the third pixel PX3, the output electrode of the sensing element Qp and the input electrode of the switching element Qs are connected to each other without the connecting member CB.

Since this structure requires no step for forming contact holes, the manufacturing process may be simplified.

As describe above, a sensing unit is disposed on two pixels to increase the transmissive area, thereby increasing the transmittance.

In addition, the sensor data lines are disposed opposite the image data lines with respect to the pixels such that the sensor data signals are less affected by the image data signals. Furthermore, the sensor data signals are covered with the input voltage lines supplying a constant voltage to reduce the electrical coupling between the sensor data lines and the pixel electrodes and the common electrode.

The above-described embodiments can be also applied to other display devices such as organic light emitting diode display, field emission display, plasma display panel, etc.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A display panel comprising:
a first pixel occupying a first pixel area;
a second pixel occupying a second pixel area, the second pixel being positioned adjacent to the first pixel area;
a sensing element disposed in the first pixel area, the sensing element being operative to generate an output signal in response to a touch exerted on the display panel; and
a switching element disposed in the second pixel area, the switching element being electrically coupled to the sensing element, wherein the switching element is selectively operable to output a signal received from the sensing element.

2. The display panel of claim 1, wherein the sensing element responds to a change in an amount of light received as a result of the touch.

3. The display panel of claim 1, further comprising:
an image scanning line connected to the first and the second pixels;
a first image data line connected to the first pixel;
a second image data line connected to the second pixel; and
a sensor data line coupled to the switching element.

4. The display panel of claim 3, wherein at least one of the first image data line, the second image data line, and the sensor data line is disposed-between the first pixel area and the second pixel area.

5. The display panel of claim 4, further comprising a connecting member connecting the sensing element to the switching element, and wherein the connecting member extends in a direction different than at least one of the first image data line, the second image data line, and the sensor data line.

6. The display panel of claim 4, wherein a first one of the first image data line, the second image data line, and the sensor data line is disposed on a second one of the first image data line, the second image data line, and the sensor data line.

7. The display panel of claim 3, wherein at least one of the first image data line, the second image data line, and the sensor data line is disposed in the first pixel area or the second pixel area.

8. The display panel of claim 3, wherein none of the first image data line and the second image data line is disposed between the first pixel area and the second pixel area.

9. The display panel of claim 8, wherein none of the first image data line, the second image data line, and the sensor data line is disposed between the first pixel area and the second pixel area.

10. The display panel of claim 9, wherein at least one of the first image data line, the second image data line, and the sensor data line is disposed in the first pixel area or the second pixel area.

11. The display panel of claim 3, further comprising an input voltage line connected to the sensing element.

12. The display panel of claim 11, wherein at least one of the first image data line, the second image data line, the sensor data line, and the input voltage line is disposed between the first pixel area and the second pixel area.

13. The display panel of claim 12, wherein the input voltage line is disposed on one of the first image data line, the second image data line, and a sensor data line.

14. The display panel of claim 11, wherein at least one of the first image data line, the second image data line, the sensor data line, and the input voltage line is disposed in the first pixel area or the second pixel area.

15. The display panel of claim 14, wherein none of the first image data line, the second image data line, the sensor data line, and the input voltage line is disposed between the first pixel area and the second pixel area.

16. The display panel of claim 11, wherein the image scanning line is located in a first layer of material and the first image data line and the second image data line are located in a second, different layer of material.

17. The display panel of claim 16, wherein the first pixel and the second pixel each include a pixel electrode disposed in a third layer of material different from the first and the second layers of material.

18. The display panel of claim 17, wherein the sensor data line and the input voltage line are located in the second layer or the third layer.

19. The display panel of claim 18, further comprising:
a sensor scanning line connected to the switching electrode, wherein the sensor scanning line is located in the first layer of material; and
a control voltage line connected to the sensing element, wherein the control voltage line is located in the first layer of material.

20. The display panel of claim 1, wherein one or both of the sensing element and the switching element include amorphous silicon or polysilicon.
